(19) United States
(12) Patent Application Publication
(10) Pub. No.: US 2012/0154674 A1
(43) Pub. Date: Jun. 21, 2012

(54) IMAGE-PICKUP APPARATUS

(75) Inventor: Norikazu Hirota, Chigasaki-shi (JP)

(73) Assignee: CANON KABUSHIKI KAISHA, Tokyo (JP)

(21) Appl. No.: 13/313,597

(22) Filed: Dec. 7, 2011

(30) Foreign Application Priority Data
Dec. 15, 2010 (JP) 2010-279190

(51) Int. Cl. H04N 5/225

(52) U.S. Cl. 348/374; 348/E05.024

(57) ABSTRACT

An image-pickup apparatus 101 includes a camera unit 315 that includes an image-pickup lens 102 and an image-pickup element 302, a circuit substrate 304 on which a power circuit 306 and a camera control circuit 305 that performs a driving control of the camera unit are mounted, and a battery housing that houses a battery 116 to supply an electric power to the power circuit 306. The camera control circuit 305 is mounted on a first surface on which the camera unit 305 is piled in the circuit substrate 304, and the power circuit 306 is mounted on a second surface on which the battery housing is piled in the circuit substrate 304.

### BACKGROUND OF THE INVENTION

1. Field of the Invention

The present invention relates to a small and portable image-pickup apparatus.

2. Description of the Related Art

Recently, a lot of digital video cameras use a nonvolatile semiconductor memory as a storage medium. Conventionally, a tape is used as a storage medium for a motion picture and the like, which need a high-capacity data area, and a memory card type recorder which uses a nonvolatile semiconductor memory is used as a storage medium for low-capacity data, such as a still picture. Therefore, as disclosed in Japanese Patent Laid-Open No. (“JP”) 2001-053994, a layout that utilizes both the two storage mediums has been proposed.

However, in video cameras that have used the tape as the main storage medium, an increasing number of video cameras use the nonvolatile semiconductor memory as the main storage medium along with the price reduction of the nonvolatile semiconductor memory of recent years. Therefore, the size of the main body of the video camera depends upon efficient arranging of a camera unit, a circuit substrate, and a battery housing.

### SUMMARY OF THE INVENTION

The present invention provides a small image-pickup apparatus in which a camera unit, a circuit substrate, and a battery housing are efficiently arranged.

An image-pickup apparatus as one aspect of the present invention includes a camera unit that includes an image-pickup lens and an image-pickup element, a circuit substrate on which a power circuit and a camera control circuit that performs a driving control of the camera unit are mounted, and a battery housing that houses a battery to supply an electric power to the power circuit. The battery housing is arranged on a bottom side of the image-pickup apparatus, the circuit substrate and the camera unit are arranged to be piled in a height direction of the image-pickup apparatus, the camera control circuit is mounted on a first surface on which the camera unit is piled in the circuit substrate, and the power circuit is mounted on a second surface on which the battery housing is piled in the circuit substrate.

Further features of the present invention will become apparent from the following description of exemplary embodiments with reference to the attached drawings.

### BRIEF DESCRIPTION OF THE DRAWINGS

FIGS. 1A-1E illustrate external views of a digital video camera 101 according to this embodiment.

FIGS. 2A-2B illustrate external views of the digital video camera 101 according to this embodiment.

FIGS. 3A-3B illustrate schematic internal configurations of the digital video camera 101 according to this embodiment.

### DESCRIPTION OF THE PREFERRED EMBODIMENTS

Hereinafter, the preferred embodiment of the present invention will be described in reference to the drawing.

### Embodiment 1

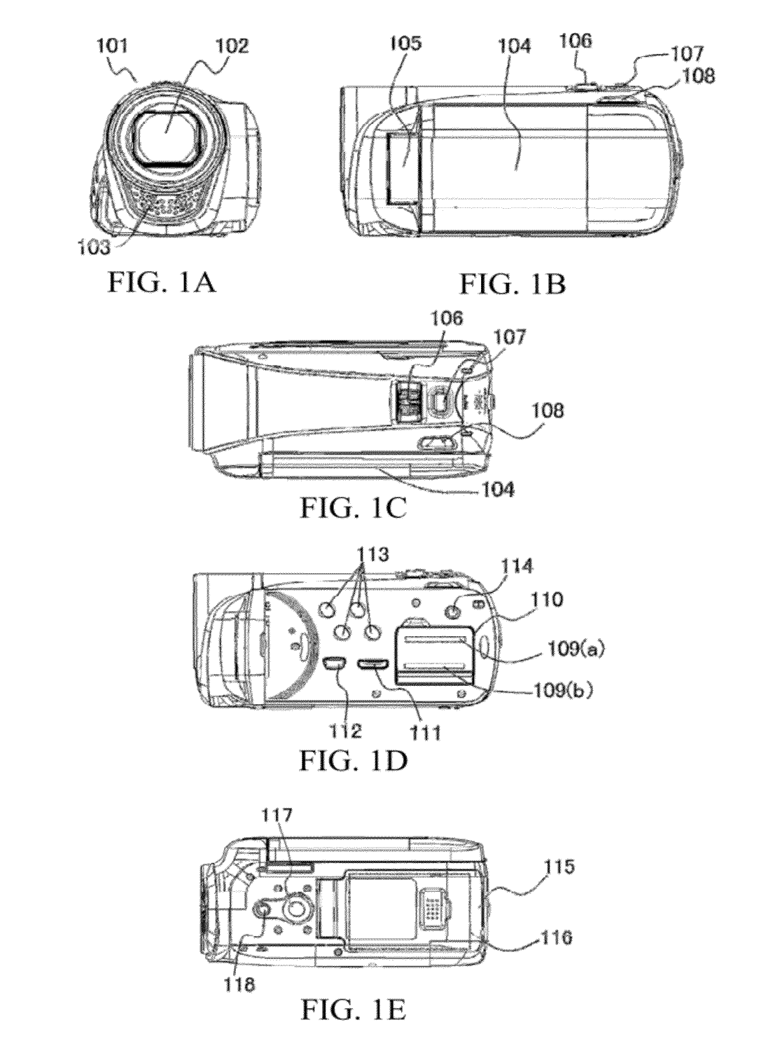

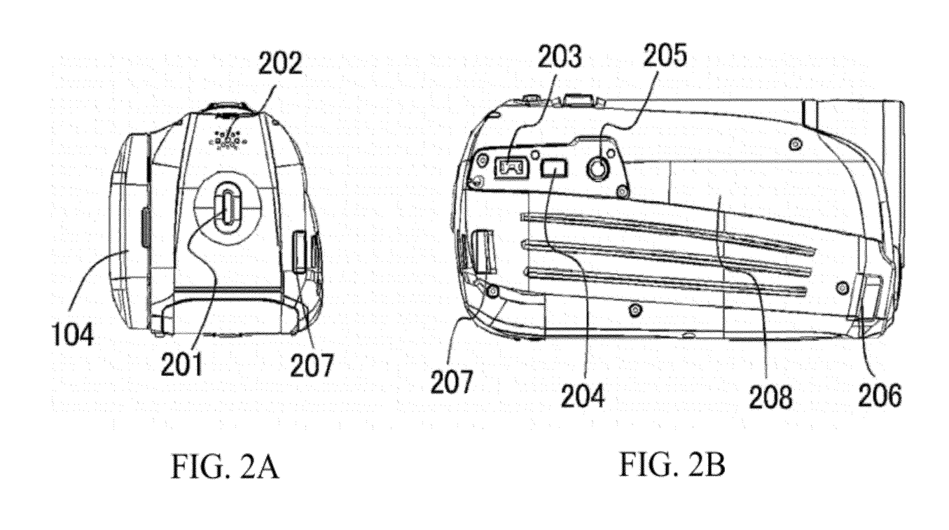

FIGS. 1A-1E and 2A-2B illustrate external views of a digital video camera 101 according to this embodiment. FIG. 1A illustrates a front view of the digital video camera 101. FIG. 1B illustrates a right side view of the digital video camera 101. FIG. 1C illustrates a top view of the digital video camera 101. FIG. 1D illustrates a right side view of the digital video camera 101 where a display is opened. FIG. 1E illustrates a bottom view of the digital video camera 101. FIG. 2A illustrates a back view of the digital video camera 101, and FIG. 2B illustrates a left side view of the digital video camera 101.

As illustrated in FIG. 1A, the digital video camera 101 has an opening portion of an image-pickup lens 102 on a front surface thereof, and the front surface faces an object in taking its image. Moreover, an opening portion 103 of a microphone that records a voice, a sound and the like is provided on the front surface.

As illustrated in FIG. 1B, a display (unit) 104 is arranged on a right side surface of the digital video camera 101 via a biaxial hinge 105. The display 104 has a liquid crystal display etc., like a general video camera, and is configured to display taken images and the like. The display 104 is configured to open and close and to rotate using the biaxial hinge 105. A zooming switch 106, a photo button 107, and a power button 108 are arranged on a top surface of the digital video camera 101. These operating switches (manipulators) act similar to those in the general video camera: The zooming switch 106 is used for an instruction of driving of the image-pickup lens or an input of a digital zoom function and to determine an angle of view. The photo button 107 is used for an instruction of still image pickup, and the power button 108 is used for an instruction of turning on and off of the power.

As illustrated in FIG. 1C, the above-mentioned three operating switches are arranged on the top surface of the digital camera 101. As illustrated in FIG. 1C, the display 104 is arranged along the right side surface of the main body. For example, when the digital video camera 101 is carried around without use thereof, the display 104 is disposed at a position shown in figure as a so-called storage state, and is along the right side surface of the main body.

FIG. 1D illustrates the right side view where the display 104 of the digital video camera 101 is opened. Unlike the above-mentioned storage state, when the digital video camera 101 is used, a user opens the display 104 as illustrated in FIG. 1D to sight the display. Elements illustrated in FIG. 1D are arranged on a surface facing the display 104 of the digital video camera 101. First, two memory card slots 109A and 109B are arranged in a memory card lid 110. The memory card as a recording medium is inserted into the memory card slot, and used to record taken images and the like. These two memory card slots provide long photographing, image copying between the memory cards, or the like, and improve the user's convenience. An opening portion of a HDMI terminal 111 and an opening portion of a USB terminal 112 are arranged in the same surface. An operating button 113 is arranged on the same surface, and is configured to switch between a reproduction and an image pickup, to display a battery remaining amount, to switch an image pickup mode, and to display an image pickup menu. An external microphone terminal 114 is arranged at a position illustrated in FIG. 1D.

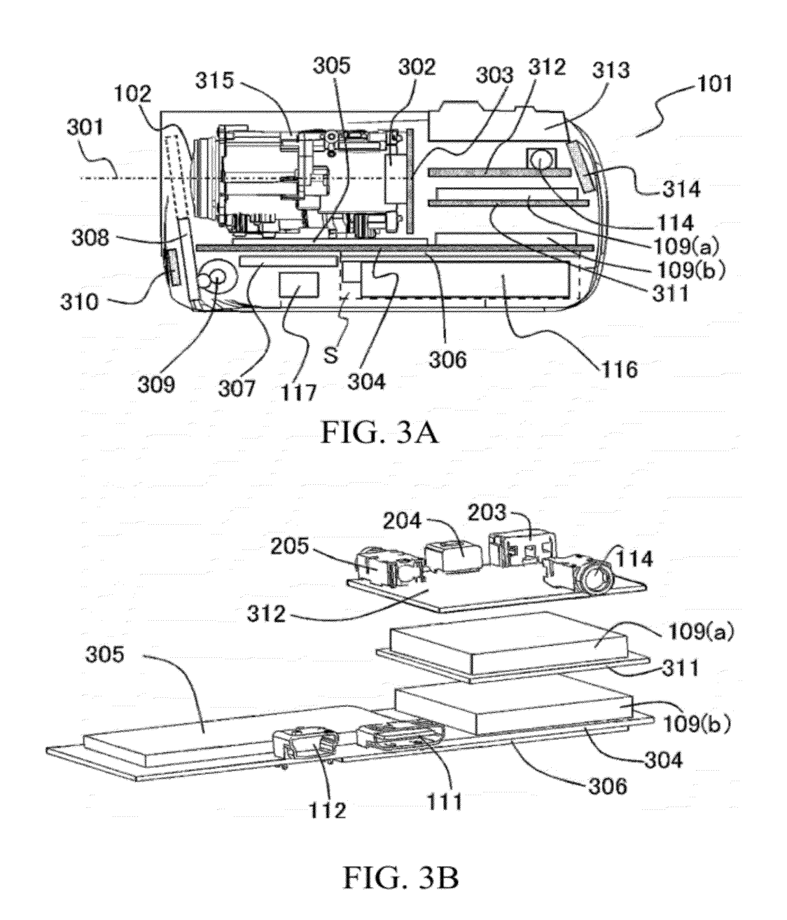

As illustrated in FIGS. 1E and 3A, arranged on a bottom side of the digital video camera 101 are a battery housing S configured to house a battery 116 to supply a power to a power circuit 306, and a battery lid 115 configured to open and close the battery housing S. A location of the battery 116 will be described in detail later. On this surface, a tripod socket 117 is arranged on the front surface side of the battery lid 115. A pin receiving hole 118 is configured to prevent a rotation of a tripod.

As illustrated in FIG. 2A, a trigger button 201 is arranged on the back surface of the digital video camera 101. The trigger button 201 is used for an instruction of start or stop of the image pickup similar to a trigger button of the general video camera. Moreover, a speaker opening portion 202 is provided on the back surface. In FIG. 2A, the back surface of the digital video camera 101 curves like an arc in appearance around the trigger button 201 as a vertex. The speaker opening portion 202 is configured along this curved shape, and an internal speaker unit is installed diagonally. The inside of the speaker will be described with reference to FIGS. 3A-3B.

As illustrated in FIG. 2B, arranged on a left side surface of the digital video camera 101 are an opening portion of a power supply terminal 203, an opening portion of a video output terminal 204, and an opening portion of a video/headphone output terminal 205. Since the digital video camera 101 is configured so that a user can grip its left side like a general video camera, there are two slots that lace a belt for holding back of user's hand are configured in a front side 206 and a back side 207. The slot in the back side 207 is integrated with a cover member 208 that forms opening portions for terminals 203 to 205. The slot in the back 207 opens on the left side surface and the back surface of the digital video camera 101, and holds the belt at a corner portion between the left side surface and the back surface. Therefore, since the belt slot can be formed without a projection on the left side surface and is disposed on the back end of the main body, the main body is easy to hold. Moreover, since a special member is not used, a portion where the belt is hooked can be inexpensively formed.

FIGS. 3A-3B illustrate schematic internal configurations of the digital video camera 101. FIG. 3A illustrates a schematic diagram of the internal configuration around a center of the image-pickup lens when the digital video camera 101 is viewed from the right side. FIG. 3B illustrates a perspective view for an explanation of only the substrate configuration.

As illustrated in FIG. 3A, the battery housing S that houses the battery 116 is arranged on the bottom side of the digital video camera 101. The battery housing S, a circuit substrate 304, and a camera unit 315 are piled in the height direction of the digital video camera 101.

An optical axis 301 of the image-pickup lens 102 is as illustrated in FIG. 3A. The image-pickup lens 102 is arranged in front of the camera unit 315. An image-pickup element 302 configured to convert an image formed by the image-pickup lens into an electric signal is arranged behind the camera unit 315. This image-pickup element 302 is mounted on an image-pickup element mounting substrate 303. The image pickup element in this embodiment can use a CMOS or a CCD. A circuit substrate 304 is arranged parallel to the optical axis 301 on the bottom side of the camera unit 315. In other words, the optical axis 301 is orthogonal to a normal of a principal surface of the circuit substrate 304. The circuit substrate 304 is the largest substrate mounted with the main control circuits of the digital video camera 101, and thus is a key ingredient of an entire length of the main body in an optical axis direction. A camera control circuit 305 is mounted on the camera unit 315 side of the circuit substrate 304. The camera control circuit 305 is a circuit configured to control driving of the camera unit 315, to control the image-pickup element 302 and the image-pickup element mounting substrate 303, to perform image processing, or the like. The circuit substrate 304 and the image-pickup element mounting substrate 303 are connected to each other with a flexible print circuit substrate, a wire, or the like (not shown). In general, a high speed signal is used for a communication between the image-pickup element mounting substrate 303 and the camera control circuit 305, and therefore is likely to cause noises. Accordingly, for connections with the shortest distance, the camera control circuit is mounted in the camera unit 315 side (first surface side) of the circuit substrate 304. The above-mentioned HDMI terminal 111, USB terminal 112 and memory card slot 109B are mounted as illustrated in FIG. 3B. The battery housing S is arranged on a surface opposite the camera unit 315 with respect to the circuit substrate 304. The battery housing S has an approximately rectangular parallelepiped shape, and its longitudinal direction is parallel to the optical axis 301 or the optical axis 301 is orthogonal to the normal of the principal surface of the battery housing S. The power circuit 306 is mounted on the battery housing side (second surface side) of the circuit substrate 304. The power circuit 306 is a circuit configured to control feeding, charging, and the like of the digital video camera 101. The circuit substrate 304 and the battery 116 that is housed in the battery housing S are connected with each other by a flexible printed circuit substrate or a wire (not shown). The battery 116 and the power circuit 306 use analog signals and are susceptible to noises from other signals. Accordingly, for connections between the battery 116 and the power circuit 306 with the shortest distance, the power circuit 306 is mounted on the battery housing S side of the circuit substrate 304.

The tripod socket 117 is arranged in front of the battery housing S in the optical axis direction, and a built-in memory substrate 307 is arranged above the tripod socket 117. In other words, the tripod socket 117 and the built-in memory substrate 307 are piled in the height direction of the digital video camera 101, and the tripod socket 117 and the built-in memory substrate 307 are approximately level with the battery housing S in the height direction of the digital video camera 101.

An electric barrier 308 is configured to protect the surface of the image pickup lens 102 and arranged in front of the digital video camera 101 in the optical axis direction. The electric barrier 308 is configured, by a barrier drive motor 309 and a gear row, to move between an exposing position of the image pickup lens 102 and a protecting position of the image-pickup lens 102. Although this embodiment drives the barrier using the barrier drive motor 309, a mechanism, such as a gear row, may be arranged at a position of the barrier drive motor 309 for a manual barrier. A microphone unit 310 is arranged in front of the electric barrier 308 in the optical axis direction. The barrier drive motor 309 and the microphone unit 310 are approximately level with the battery housing S in the height direction of the digital video camera 101.

As illustrated in FIG. 3A, the camera unit 315 and the battery 116 are arranged at positions different from each other in the height direction of the digital video camera 101. The camera unit 315 and the battery 116 shift with respect to the optical axis 301 or the circuit surface 304. In other words, a surface that is the closest to the object among surfaces orthogonal to the principal surface of the battery 116 is arranged between a plane surface including the image-pickup lens 102 of the camera unit 315 and a plane surface including the image-pickup element 302. The tripod socket 117, the built-in memory substrate 307, and the barrier drive motor 309 are arranged in front of a space generated by the shift in the front-back direction, in the optical axis direction. Components of the biaxial hinge 105 may be arranged in this space. A microphone unit, an illuminator, such as a LED light and a strobe, or an electric component, such as a condenser, may also be arranged in this space.

A memory card slot substrate 311 and a terminal substrate 312 are piled behind the camera unit 315 in the optical axis direction of the camera unit 315. The memory card slot substrate 311 and the terminal substrate 312 are approximately level with the camera unit 315 in the height direction of the digital video camera 101.

The memory card slot substrate 311 is mounted with the memory card slot 109A, and the terminal substrate 312 is mounted with the external microphone terminal 114 and the power terminal 203 as external connection terminals, the video output terminal 204, and an input-output terminal, such as a video/headphone output terminal 205. The mechanism housing 313 for the zooming switch 106 and the photo button 107 are arranged above the terminal substrate 312. As illustrated in FIG. 3B, each terminal is mounted on the terminal substrate 312 so that the external microphone terminal 114 is exposed from an opening portion on a surface facing the display 104 in the right side of the main body, and the other three terminals are exposed from an opening portion provided on the left side surface of the main body. Moreover, as mentioned above, the speaker unit 314 is arranged under the speaker opening portion 202 as illustrated in FIG. 3A.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, a digital video camera has been described as an example of this embodiment, but this embodiment is also applicable to a digital still camera, a personal digital assistance, a mobile phone, and the like.

This application claims the benefit of Japanese Patent Application No. 2010-279190, filed on Dec. 15, 2010, which is hereby incorporated by reference herein in its entirety.

What is claimed is:

1. An image-pickup apparatus comprising:
a camera unit that includes an image-pickup lens and an image-pickup element;
a circuit substrate mounted with a power circuit and a camera control circuit configured to control driving of the camera unit; and
a battery housing configured to house a battery to supply an electric power to the power circuit,
wherein the battery housing is arranged on a bottom side of the image-pickup apparatus, and the battery housing, the circuit substrate, and the camera unit are piled in a height direction of the image-pickup apparatus,
wherein the camera control circuit is mounted on a first surface of the circuit substrate, on which the camera unit is piled, and
wherein the power circuit is mounted on a second surface of the circuit substrate, on which the battery housing is piled.

2. The image-pickup apparatus according to claim 1, wherein the battery housing is arranged behind the camera unit in an optical axis direction of the image-pickup apparatus.

3. The image-pickup apparatus according to claim 1, further comprising a tripod socket arranged in front of the battery housing in an optical axis direction of the image-pickup apparatus, and about level with the battery housing in the height direction of the image-pickup apparatus.

4. The image-pickup apparatus according to claim 1, further comprising a barrier driver arranged in front of the battery housing in an optical axis direction of the image-pickup apparatus, and about level with the battery housing in the height direction of the image-pickup apparatus.

5. The image-pickup apparatus according to claim 1, further comprising a microphone arranged in front of the battery housing in an optical axis direction of the image-pickup apparatus, and about level with the battery housing in the height direction of the image-pickup apparatus.

6. The image-pickup apparatus according to claim 1, further comprising a memory card slot substrate to be mounted with a memory card slot, the memory card slot being arranged behind the camera unit in an optical axis direction of the image-pickup apparatus, and level with the camera unit in the height direction of the image-pickup apparatus.

7. The image-pickup apparatus according to claim 1, further comprising a terminal substrate to be mounted with an external connection terminal, the terminal substrate being arranged behind the camera unit in an optical axis direction of the image-pickup apparatus, and level with the camera unit in the height direction of the image-pickup apparatus.
